(19) United States
(12) Patent Application Publication
(10) Pub. No.: US 2010/0152016 A1
(43) Pub. Date: Jun. 17, 2010

(54) Method For Producing Carbon-Containing Silicon Carbide Ceramic

(76) Inventors: Mikio Sakaguchi, Wakayama (JP); Keisaku Inoue, Wakayama (JP); Hiroki Hoshida, Wakayama (JP)

Correspondence Address: BIRCH STEWART KOLASCH & BIRCH, PO BOX 747, FALLS CHURCH, VA, 22040-0747, US

(21) Appl. No.: 12/223,184

(22) PCT Filed: Jan. 24, 2007
(86) PCT No.: PCT/JP2007/051089

§ 371 Date: Jul. 24, 2008

(30) Foreign Application Priority Data
Jan. 25, 2006 (JP) 2006-016819

(51) Int. Cl. C04B 35/565

(52) U.S. Cl. 501/90

(57) ABSTRACT

[Problems] To provide a method for industrially producing carbon-containing silicon carbide ceramics having excellent structural and other various physical properties after sintering, especially density and strength. [Solving Means] A method for producing carbon-containing silicon carbide ceramics including the step of burning a mixture X of raw materials containing silicon carbide, a carbon raw material, and a sintering aid, wherein the particles constituting the mixture X have an average particle size of from 0.05 to 3 μm.

### TECHNICAL FIELD

The present invention relates to a method or producing carbon-containing silicon carbide ceramics having excellent sinterability, ceramics obtained by the method, and a sliding member or a high-temperature structural member made of the ceramics.

### BACKGROUND ART

Since silicon carbide ceramics have excellent hardness, heat resistance, corrosion resistance, or the like, their applications as structural members have been positively studied in the recent years. Especially, the silicon carbide ceramics have been partly actually used as a structural member, such as a mechanical seal or a bearing.

On the other hand, no disclosures of techniques remarking on the conditions capable of stably producing silicon carbide ceramics having excellent quality on a production level have yet been made.

For example, Patent Publication 1 discloses a method for producing silicon carbide ceramics including the steps of mixing a specified carbon raw material together with silicon carbide and a sintering aid, and sintering the mixture under conditions that a given volatile component is contained, in order to obtain close-packed silicon carbide ceramics.
Patent Publication 1: JP-A-Hei-6-206770

### DISCLOSURE OF INVENTION

### Problems to be Solved by the Invention

An object of the present invention is to provide a method for industrially producing carbon-containing silicon carbide ceramics having excellent structural and other various physical properties after sintering, especially density and strength, and to provide carbon-containing silicon carbide ceramics having excellent density and strength obtained by the method.

### Means to Solve the Problems

Specifically, the gist of the present invention relates to:

[1] a method for producing carbon-containing silicon carbide ceramics including the step of burning a mixture X of raw materials containing silicon carbide, a carbon raw material, and a sintering aid, wherein the particles constituting the mixture X have an average particle size of from 0.05 to 3 μm;

[2] carbon-containing silicon carbide ceramics obtained by the method as defined in the above [1]; and

[3] a sliding member or a high-temperature structural member made of the carbon-containing silicon carbide ceramics as defined in the above [2].

### Effects of the Invention

According to the present invention, a method for industrially producing carbon-containing silicon carbide ceramics having excellent structural and other various physical properties after sintering, especially density and strength, and carbon-containing silicon carbide ceramics having excellent density and strength obtained by the method can be provided.

### BEST MODE FOR CARRYING OUT THE INVENTION

The present invention relates to a method for producing carbon-containing silicon carbide ceramics including the step of burning a mixture X of raw materials containing silicon carbide, a carbon raw material, and a sintering aid, wherein the particles constituting the mixture X have an average particle size of from 0.05 to 3 μm. According to the method of the present invention, the carbon-containing silicon carbide ceramics having excellent density and strength can be stably produced on an industrial scale.

[Mixture X]

The mixture X can be obtained by, for example, mixing raw materials containing silicon carbide, a carbon raw material, and a sintering aid, and pulverizing the mixture. The mixing or pulverization of the raw materials may be carried out in a dry process in some cases and in a wet process in other cases. In addition, there are an embodiment including the steps of mixing raw materials, then calcining the mixture, and subsequently pulverizing the calcined mixture (Embodiment 1); and an embodiment including the step of concurrently carrying out mixing and pulverization of the raw materials (Embodiment 2). In the case of Embodiment 1, silicon carbide and carbon are closely packed in the carbon-containing silicon carbide ceramics obtained after burning (which may be hereinafter simply referred to as “ceramics”), so that the relative density of the ceramics can be improved. In addition, in the case of Embodiment 2 in which the particles constituting the mixture X have an average particle size of from 0.05 to 3 μm, ceramics having excellent density and strength can be obtained without including a calcining step, thereby making it unnecessary to carry out the calcining step, thereby making it possible to simplify the production steps.

[Silicon Carbide]

The silicon carbide used in the method of the present invention may take any of α and β crystal forms. The purity of the silicon carbide is not particularly limited, and the purity is preferably 90% by weight or more, and more preferably 95% by weight or more, from the viewpoint of giving the ceramics excellent sintered body density, strength, and fracture toughness, and also improving mechanical properties such as Young's modulus. In addition, as the form of the silicon carbide, the silicon carbide is preferably a powder having an average particle size of 5 μm or less, and more preferably a powder having an average particle size of 0.1 to 3 μm, in order to have excellent sinterability.

[Carbon Raw Material]

The carbon raw material used in the method of the present invention refers to an organic substance having a conversion ratio to carbon after burning of from 50 to 95% by weight, and in a case where a carbon raw material is used in mixing in a wet process, the carbon raw material is not particularly limited so long as the carbon raw material shows solubility or excellent dispersibility in a solvent. The conversion ratio of the carbon raw material to carbon after burning is preferably from 50 to 90% by weight, from the viewpoint of improving the relative density of the ceramics. In addition, from the same viewpoint, its average particle size is preferably from 5 to 200 μm. The carbon raw material is preferably an aromatic hydrocarbon, because of its high conversion ratio to carbon after burning. The aromatic hydrocarbon includes, for example, furan resins, phenolic resins, coal-tar pitch, and the like, among which the phenolic resins and coal-tar pitch are more preferably used. Here, the conversion ratio of the carbon raw material to carbon after burning refers to a weight percentage (%) of a fixed carbon in the carbon raw material determined on the basis of JIS K2425.

[Sintering Aid]

The sintering aid used in the method of the present invention is not particularly limited so long as the sintering aid is one that is ordinarily selected as a sintering aid in the production of ceramics, and any one of them can be used. The sintering aid includes, for example, boron-containing compounds such as B and B₄C, aluminum compounds, yttria compounds, and the like. Specific examples of the aluminum compounds and the yttria compounds includes oxides such as Al₂O₃ and Y₂O₃, and the like.

[Other Components]

Other components that can be used as raw materials in the method of the present invention include additives ordinarily used in the production of ceramics, including, for example, TiC, TiN, Si₃N₄, and AlN.

The content ratio of carbon to silicon carbide [C (% by weight)/SiC (% by weight)] in the ceramics obtained by the method of the present invention is from preferably from 5/95 to 45/55, more preferably from 10/90 to 40/60, and even more preferably from 15/85 to 35/65, from the viewpoint of improving relative density and flexural strength of the ceramics.

Therefore, the mixing ratio of the silicon carbide, the carbon raw material, and the sintering aid upon mixing is not particularly limited, and it is preferable that the carbon raw material and the silicon carbide are used together with the sintering aid in a ratio calculated so that the resulting ceramics satisfy the above-mentioned content ratio. As the amount of the sintering aid used, the sintering aid is usually mixed in an amount of preferably from 0.1 to 15% by weight, more preferably from 0.2 to 10% by weight, even more preferably from 0.5 to 5% by weight, and still even more preferably from 1 to 3% by weight, based on 100% by weight of the silicon carbide. In a case where other components are used, given amounts thereof may be mixed therewith upon mixing.

Also, the silicon carbide is contained in an amount of preferably from 54 to 94% by weight, more preferably from 60 to 90% by weight, and even more preferably from 65 to 85% by weight, of the ceramics, from the viewpoint of improving relative density and flexural strength of the ceramics.

### Embodiment 1

As a method of mixing the above-mentioned raw materials, any one of the methods, such as mixing in a dry process, mixing in a wet process, or a hot kneading, and the mixing in a wet process is preferred, from the viewpoint of dispersibility of the carbon raw material.

As a solvent used in the mixing in a wet process, either one of water or an organic solvent may be used. An organic solvent is preferably used, from the viewpoint of dispersibility of the carbon raw material, and oxidation resistance of the silicon carbide. Water is preferably used, from the viewpoint environmental-friendliness.

As the organic solvent, for example, an alcoholic solvent such as methanol, ethanol, or propanol, an aromatic hydrocarbon solvent such as benzene, toluene, or xylene, a ketone solvent such as methyl ethyl ketone, or the like can be used.

As a mixing apparatus, a general mixer can be used. The mixer includes, for example, pot mills such as a ball mill and a vibration mill, agitation mills such as a sand mill and an attritor mill, and mills thereof in a continuous process, but not limited thereto.

Next, the resulting mixture is calcined. In a case where mixing in a wet process is carried out, it is preferable to perform desolvation by a known method before calcination. The calcination is carried out preferably in a non-oxidative atmosphere at a temperature preferably from 200° to 600° C., more preferably from 300° to 500° C., and even more preferably from 400° to 500° C. for a period of preferably from 0.5 to 12 hours, and more preferably from 1 to 10 hours. In a case where the calcination is carried out at a temperature of 200° C. or higher, a volatile component is appropriately evaporated, so that the porosity of the ceramics obtained after burning can be reduced. In addition, in a case where the calcination is carried out at a temperature of 600° C. or lower, the sinterability of the carbon can be maintained, so that a close-packed sintered body can be obtained. The above-mentioned non-oxidative atmosphere may be any one of nitrogen gas, argon gas, helium gas, carbon dioxide gas, or a mixed gas thereof, or vacuum. In some cases, the calcination may be carried under pressure with a gas.

The calcined body obtained by the above-mentioned calcination is pulverized to a given average particle size, namely a size of from 0.05 5o 3 μm by pulverization in a dry or wet process. It is preferable that the pulverization is carried out in a wet process from the viewpoint of pulverization efficiency. The pulverization in a wet process may be carried out by using a known pulverizer, for example, a ball mill, a vibration mill, a planetary mill attritor, or the like. As a solvent to be used in the pulverization, for example water is preferred, from the viewpoint of environmental-friendliness. Also, an aromatic solvent such as benzene, toluene, or xylene, an alcoholic solvent such as methanol or ethanol, a ketone solvent such as methyl ethyl ketone, or the like can be used. As other solvents, a mixed solvent of water and the above-mentioned organic solvent can also be used. The solvent may be usually used in an amount of 50 to 200% by weight or so, based on 100% by weight of the mixture of the raw materials as described above.

### Embodiment 2

The mixing and the pulverization of the above-mentioned raw materials are concurrently carried out, whereby pulverizing the mixture of the raw materials so as to have an average particle size of from 0.05 to 3 μM. The mixing and the pulverization may be either one of the method in a dry process or that in a wet process. It is preferable that the mixing and the pulverization are carried out in a wet process, from the viewpoint of the dispersibility of the carbon raw material. As a solvent to be used in the mixing in a wet process and the pulverization, either water or an organic solvent may be used. An organic solvent is preferably used, from the viewpoint of dispersibility of the carbon raw material and oxidation resistance of silicon carbide. Water is preferably used, from the viewpoint of environmental-friendliness. As the organic solvent, the same ones as those used in the mixing in a wet process of Embodiment 1 can be used: An apparatus for concurrently carrying out mixing and pulverization includes, for example, pot mills such as a ball-mill and a vibration mill, agitation mills such as a sand mill and an attritor mill, and mills thereof in a continuous process, without being limited thereto.

One of the features of the method of the present invention resides in that in the mixture X which can be prepared as described above, the particles constituting the mixture X have an average particle size of from 0.05 to 3 μm, preferably from 0.1 to 2.5 μm, more preferably from 0.15 to 1.5 μm, and even more preferably from 0.2 to 1.2 μM. One of the features of the method of the present invention resides in that in the mixture X the particles constituting the mixture X have an average particle size of from 0.05 to 3 μm, preferably from 0.05 to 2.5 μm more preferably from 0.05 to 1.2 μm, and even more preferably from 0.05 to 0.15 μM, from the viewpoint of securing excellent relative density and flexural strength.

In a case where the average particle size satisfies the above-mentioned preferred range, sintering of the mixture of raw materials is accomplished in good balance despite the difference in the preferred sintering temperatures of the carbon and the silicon carbide, thereby exhibiting an effect that ceramics having excellent density and strength are produced. The effect can be more preferably exhibited in a case where the method of the present invention includes the calcining step.

The term “average particle size” as used in the present invention means D50, i.e. a particle size at 50% counted from a smaller particle side in a cumulative particle size distribution (volume basis). The average particle size is determined by laser diffraction/scattering method. Specifically, the average particle size is determined by using an apparatus under the trade name of LA-920 (manufactured by Horiba, LTD.).

A means of adjusting the average particle size of the particles constituting the mixture X within a desired particle size range is not particularly limited. The means includes, for example, adjusting setting conditions of a pulverizing apparatus. For example, in a case where a vibration mill is used as a pulverizing apparatus, the pulverization may be carried out by using zirconia balls as pulverizing media.

According to the method of the present invention, carbon-containing silicon carbide ceramics are obtained by burning the above-mentioned mixture X. Specifically, carbon-containing silicon carbide ceramics are obtained by, for example, filling a mixture X in a mold previously subjected to a treatment of preventing escape to mold the mixture, or granulating a mixture X with a spray-dryer and filling the resulting granules in a mold to mold the mixture; and thereafter burning the molded product. Here, the term burning refers to a heat treatment necessary for sintering the particles constituting the mixture X.

In addition, the volatile component is contained in an amount of preferably from 0.1 to 10% by weight, more preferably from 0.2 to 8% by weight, and even more preferably from 0.3 to 8% by weight, of the mixture X, from the viewpoint of obtaining close-packed ceramics. In a case where the volatile component is contained in an amount of 0.1% by weight or more of the mixture X, sinterability ascribed to the carbon during burning can be sufficiently exhibited, whereby a close-packed sintered body can be obtained. In a case where the volatile component is contained in an amount of 10% by weight or less of the mixture X, the generation of cracks due to evaporation of the volatile component during burning, and a generation ratio of the remaining pores after burning can be reduced, whereby a close-packed sintered body can be obtained. A means of adjusting the amount of the volatile component contained includes calcination, and the amount contained can be reduced by the calcination.

In the present invention, the amount of the volatile component contained in the mixture X is obtained in the following manner. Specifically, a mixture X is dried at 130° C. for 16 hours for the purpose of the removal of the solvent, and the dried mixture is then packed in a die (φ 60 mm), and molded so as to have a thickness of 9 mm under pressure of 147 MPa, to give a molded product. The weight of the molded product and the weight of a sintered body obtained after burning the molded product at 2150° C. for 4 hours are determined with a chemical balance, and the amount of the volatile component contained is calculated by the following formula:

$$Amount of Volatile Component Contained ( \% by weight ) = \frac{Weight of Molded Product - Weight of Sintered Body}{Weight of Molded Product} \times 100$$

[Granulation]

The granulation method is not particularly limited. The method includes, for example, a method of treating a mixture X with a granulator such as a spray-dryer. During the granulation, a binder for molding can be added where necessary. As the shape of the granules obtained after the granulation, the granules are preferably spherical which are highly fluidal, and have an average particle size of preferably from 20 to 150 μm, from the viewpoint of packability into a mold.

[Molding]

A molding method is not particularly limited. The method includes, for example, general molding methods, such as a die molding method, CIP (Cold Isostatic Press) method, and a slip casting method in which a mixture X is directly used without granulation. In some cases, after the molding, the resulting molded product is worked. The molding die is not particularly limited. Since the molded product produced in the present invention can contain a proper amount of a volatile component, the molded product has a high strength and excellent workability.

[Dewaxing]

A dewaxing is carried out where necessary, in a non-oxidative atmosphere. As a non-oxidative atmosphere gas, the same ones as those used in the calcining step are used. It is preferable that the dewaxing temperature is usually from 300° to 1400° C.

[Burning]

The burning method is not particularly limited, and sintering is preferably carried out at a burning temperature of from 1900° to 2300° C. under normal pressure. The burning time is usually from 0.5 to 8 hours. The ceramics of the present invention can be obtained in the form of a close-packed, high-strength sintered body by controlling a burning temperature within the range of from 1900° to 2300° C. An atmosphere during burning is preferably vacuum, or a non-oxidative atmosphere in the same manner as above. As the burning method, hot press, HIP(Hot Isostatic Press) method, or the like may be used, in order to highly densify the ceramics.

One example of the method for producing carbon-containing silicon carbide ceramics of the present invention includes the steps of (I) pulverizing a mixture of raw materials containing silicon carbide, a carbon raw material, and a sintering aid so as to give particles having an average particle size of from 0.05 to 3 μm, and (II) filling a pulverized product obtained in the step (I) into a mold, and burning the pulverized product, to give carbon-containing silicon carbide ceramics.

[Ceramics]

The carbon-containing silicon carbide ceramics obtained by the method of the present invention have a relative density of preferably 85% or more, more preferably 88% or more, and even more preferably 90% or more. Since the ceramics have a high relative density, the properties such as a high flexural strength and a high resistance to fracture can be exhibited. The relative density can be improved by adjusting production conditions, such as a purity of the silicon carbide, a carbon conversion ratio of the carbon raw material, a content ratio of the carbon to the silicon carbide in the ceramics, an amount of a sintering aid used, a content ratio of the silicon carbide, the carbon raw material, and the sintering aid in the mixture X, or an average particle size of the particles constituting the. mixture X, to preferred ranges mentioned above. Here, the relative density can be obtained in the manner as shown in Examples described later.

In addition, in the carbon-containing silicon carbide ceramics obtained by the method of the present invention, the diameter of the carbon domain is preferably from 0.1 to 10 μm, more preferably from 0.1 to 7 μm, and even more preferably from 0.1 to 5 μm, from the viewpoint of improving flexural strength of the ceramics. The diameter of the carbon domain means a size of carbon particles or an aggregate thereof distributed in a silicon carbide matrix. Here, the diameter of the carbon domain is calculated as an average obtained by observing roughly even 100 spots on a mirror-finished sample surface with a scanning electron microscope at a magnification of 500 folds, and analyzing the carbon domains in the 100 images obtained with an image analyzer.

In addition, in the carbon-containing silicon carbide ceramics obtained by the method of the present invention, the proportion of the carbon domain is preferably from 6 to 70% by volume, more preferably from 9 to 60% by volume, and even more preferably from 15 to 50% by volume, from the viewpoint of improving flexural strength of the ceramics. The proportion of the carbon domain means an average of a volume percentage of the carbon domain occupying the silicon carbide matrix. Here, the volume percentage of the carbon domain is calculated as an average of 100 images on % by area of the carbon domain in the one image mentioned above, in the same manner as in the diameter of the carbon domain.

The diameter of the carbon domain is more likely to increase if the conversion ratio of the carbon raw material to carbon after burning is high, and the proportion of the carbon domain is more likely to increase if an average particle size of the particles constituting the mixture X is large.

The ceramics of the present invention having the structural properties as described above have a high relative density and a large flexural strength, so that the ceramics have excellent thermal shock resistance and sliding property. For this reason, the ceramics of the present invention can be suitably used for a sliding member, such as a valve, a mechanical seal, or a bearing, or a high-temperature structural member such as a high-temperature mold or a jig for heat treatment.

The present invention also relates to a sliding member or a high-temperature structural member, made of the above-mentioned ceramics. Since the sliding member or high-temperature structural member of the present invention is made of the above-mentioned ceramics, the member has excellent thermal shock resistance and sliding property. The sliding member or high-temperature structural member of the present invention is not particularly limited, so long as the member is made of the above-mentioned ceramics. The member can be used in, for example, a sliding member, such as a valve, a mechanical seal, or a bearing, or a high-temperature structural member such as a high-temperature mold or a jig for heat treatment.

### Examples

The present invention will be specifically described hereinbelow by means of Examples and Comparative Examples, without intending to limit the scope of the present invention thereto.

### Examples 1 to 5, 9, and 10, and Comparative Examples 1 to 3

As raw materials, α-silicon carbide (average particle size: 0.7 μm and purity: 99% by weight), a carbon raw material (coal tar pitch: conversion ratio to carbon after burning: 50% by weight, and average particle size: 33 μm), and a sintering aid (B₄C) were used in formulation amounts as shown in Table 1. The raw materials were mixed in ethanol using a 5-liter vibration mill (Model No. MB, manufactured by CHUO KAKOHKI CO., LTD.), and the mixture was then subjected to desolvation. Each of the resulting mixtures was calcined for 2 hours at each of the calcination temperature shown in Table 1 under nitrogen atmosphere. The calcined mixture obtained was pulverized in a wet process with a 5-liter vibration mill (Model MB, manufactured by CHUO KAKOHKI CO., LTD.), thereby giving each of a mixture X having an average particle size as shown in Table 1. The resulting mixture X was granulated with a spray-dryer (evaporation rate: 15 L/hr) to an average particle size of 50 μm. Next, the granules were molded using a die (φ 60 mm) as a mold according to CIP method so as to have a thickness of 9 mm under the pressure of 100 MPa, and a molded product was dewaxed at 600° C. for 4 hours under nitrogen atmosphere. After dewaxing, the dewaxed product was burned at a burning temperature shown in Table 1 for 4 hours under argon atmosphere, to give a sintered body (carbon-containing silicon carbide ceramics) as a test piece.

### Examples 6 to 8 and Comparative Examples 4 to 6

As raw materials, α-silicon carbide (average particle size: 0.7 μm and purity: 99% by weight), a carbon raw material (calcined pitch: conversion ratio to carbon after burning: 90% by weight, and average particle size: 12 μm), and a sintering aid (B₄C) were used in formulation amounts as shown in Table 1. The raw materials were mixed and pulverized in water using a 15-liter vibration mill (Model No. MB, manufactured by CHUO KAKOHKI CO., LTD.), thereby giving each of a mixture X having an average particle size as shown in Table 1. The resulting mixture X was granulated, molded, dewaxed, and burned in the same manner as in Examples 1 to 5, 9, and 10, and Comparative Examples 1 to 3, to give a sintered body (carbon-containing silicon carbide ceramics) as a test piece.

[Diameter of Carbon Domain and Method for Measuring Proportion of Carbon Domain]

A sample surface obtained by mirror-finishing each of the sinter bodies obtained in Examples 1 to 10 and Comparative Examples 1 to 6 was observed at roughly even 100 spots with a scanning electron scope at a magnification of 500 folds. Each of the 100 images obtained was analyzed with an image analyzer (Model No. LUZEX-III, manufactured by NIRECO CORPORATION), each of the values was calculated as mentioned above. The results are shown in Table 2.

[Method for Determining Amount of Volatile Component Contained]

The content of the volatile component in the mixture X was measured as follows. Specifically, each of the mixture X in Examples 1 to 10 and Comparative Examples 1 to 6 was dried at 130° C. for 16 hours, and thereafter the dried mixture was packed in a die (φ 60 mm), and molded under the pressure of 147 MPa so as to have a thickness of 9 mm, to give a molding product. The weight of the molding product and the weight of a sintered body obtained after burning the molding product at 2150° C. for 4 hours were each measured with a chemical balance, and the content was calculated by the following formula. The results are shown in Table 2.

$$Amount of Volatile Component Contained ( \% by weight ) = \frac{Weight of Molded Product - Weight of Sintered Body}{Weight of Molded Product} \times 100$$

[Method for Determining Relative Density]

The density of each of the sintered bodies obtained in Examples 1 to 10 and Comparative Examples 1 to 6 was measured in accordance with JIS R1634, and the resulting density is divided by a theoretical density and multiplied by a factor of 100 to obtain a relative density. Here, the relative density can be obtained from a theoretical density of silicon carbide of 3.14 g/cm³ and a theoretical density of carbon alone of 2.26 g/cm³. The results are shown in Table 2.

[Method for Measuring Flexural Strength]

The flexural strength was measured for each of the sintered bodies obtained in Examples 1 to 10 and Comparative Examples 1 to 6 in accordance with JIS R1601. The results are shown in Table 2.

[Method for Determining Carbon Content Ratio of Carbon to Silicon Carbide]

One gram of each of the sintered bodies obtained in Examples 1 to 10 and Comparative Examples 1 to 6 was pulverized in a dry process for 20 minutes with a shaking mill using a pot made of tungsten carbide and having an inner volume of 50 ml and balls made of tungsten carbide each having a diameter of 13 mm. The resulting pulverized product was measured for its carbon content in the sintered body by performing oxidation compensation of silicon carbide in accordance with JIS R6124. In addition, the silicon carbide content in the sintered body is assumed to be the amount of the silicon carbide formulated during the production of the sintered body. The content ratio of the carbon to the silicon carbide in the sintered body is as shown in Table 2.

TABLE 1

| | Formulation Amount | | | Amount of | | | | |
|---|---|---|---|---|---|---|---|---|
| | of Raw Materials | | | Fixed Carbon in | | | | Amount of |
| | (Weight Ratio) | | | Carbon Raw | | | | Volatile Component |
| | | Carbon | | Material in the Raw | Average | Calcining | Burning | Contained in |
| | Silicon | Raw | Sintering | Materials | Particle Size | Temp. | Temp. | Mixture X |
| | Carbide | Material | Aid | (% by Weight) | (μm) | (° C.) | (° C.) | (% by Weight) |
| Ex. 1 | 80 | 40 | 2 | 20 | 0.07 | 400 | 2125 | 1.6 |
| Ex. 2 | 80 | 40 | 2 | 20 | 0.15 | 400 | 2150 | 1.9 |
| Ex. 3 | 90 | 20 | 2 | 10 | 0.2 | 400 | 2150 | 1.8 |
| Ex. 4 | 80 | 40 | 2 | 20 | 0.35 | 460 | 2190 | 2.6 |
| Ex. 5 | 60 | 80 | 2 | 40 | 0.69 | 500 | 2230 | 3.9 |
| Ex. 6 | 90 | 11 | 2 | 10 | 0.43 | — | 2160 | 1.7 |
| Ex. 7 | 80 | 22 | 2 | 20 | 0.91 | — | 2200 | 2.9 |
| Ex. 8 | 70 | 33 | 2 | 30 | 1.33 | — | 2235 | 3.9 |
| Ex. 9 | 80 | 40 | 2 | 20 | 2 | 400 | 2210 | 2.3 |
| Ex. 10 | 80 | 40 | 2 | 20 | 2.7 | 400 | 2220 | 2.1 |
| Comp. Ex. 1 | 90 | 20 | 2 | 10 | 0.03 | 400 | 2150 | 1.8 |
| Comp. Ex. 2 | 80 | 40 | 2 | 20 | 8.5 | 460 | 2190 | 2.6 |
| Comp. Ex. 3 | 60 | 80 | 2 | 40 | 5.9 | 500 | 2230 | 3.9 |
| Comp. Ex. 4 | 90 | 11 | 2 | 10 | 0.01 | — | 2160 | 1.7 |
| Comp. Ex. 5 | 80 | 22 | 2 | 20 | 9.6 | — | 2200 | 2.9 |
| Comp. Ex. 6 | 70 | 33 | 2 | 30 | 3.5 | — | 2235 | 3.9 |

TABLE 2

| | | | Carbon | | |
|---|---|---|---|---|---|
| | | Relative | Domain | Proportion of | Flexural |
| | | Density | Diameter | Carbon Domain | Strength |
| | C/SiC¹⁾ | (%) | (μm) | (% by volume) | (Mpa) |
| Ex. 1 | 20/80 | 99 | 0.3 | 25 | 605 |
| Ex. 2 | 20/80 | 98 | 1.5 | 26 | 619 |
| Ex. 3 | 10/90 | 97 | 2.1 | 14 | 540 |
| Ex. 4 | 20/80 | 96 | 3.3 | 27 | 565 |
| Ex. 5 | 40/60 | 91 | 4.9 | 49 | 539 |
| Ex. 6 | 10/90 | 95 | 2.6 | 14 | 513 |
| Ex. 7 | 20/80 | 94 | 3.6 | 26 | 506 |
| Ex. 8 | 30/70 | 91 | 5.1 | 36 | 474 |
| Ex. 9 | 20/80 | 96 | 4.8 | 26 | 486 |
| Ex. 10 | 20/80 | 95 | 5.6 | 27 | 469 |
| Comp. Ex. 1 | 10/90 | 84 | 0.1 | 13 | 310 |
| Comp. Ex. 2 | 20/80 | 81 | 21 | 26 | 315 |
| Comp. Ex. 3 | 40/60 | 79 | 13 | 47 | 289 |
| Comp. Ex. 4 | 10/90 | 81 | 0.08 | 12 | 313 |
| Comp. Ex. 5 | 20/80 | 84 | 29 | 25 | 306 |
| Comp. Ex. 6 | 30/70 | 79 | 19 | 35 | 274 |

¹⁾Weight Ratio

As shown in Table 2, the ceramics obtained by the method of the present invention are stable, high-density and high-strength sintered bodies under normal-pressure sintering.

### INDUSTRIAL APPLICABILITY

The method of the present invention can be suitably used in an industrial production of carbon-containing silicon carbide ceramics having excellent structural and other various physical properties after sintering, especially in density and strength.

1. A method for producing carbon-containing silicon carbide ceramics comprising the step of burning a mixture X of raw materials comprising silicon carbide, a carbon raw material, and a sintering aid, wherein the particles constituting the mixture X have an average particle size of from 0.05 to 3 μm.

2. The method for producing carbon-containing silicon carbide ceramics according to claim 1, wherein the mixture X is obtained by pulverizing a mixture of raw materials comprising silicon carbide, a carbon raw material, and a sintering aid.

3. The method for producing carbon-containing silicon carbide ceramics according to claim 2, wherein pulverization is carried out by wet pulverization.

4. The method for producing carbon-containing silicon carbide ceramics according to any one of claims 1 to 3, wherein the mixture X contains volatile components in an amount of from 0.1 to 10% by weight.

5. The method for producing carbon-containing silicon carbide ceramics according to any one of claims 1 to 4, wherein a content ratio of carbon to silicon carbide in the carbon-containing silicon carbide ceramics [C (% by weight)/SiC (% by weight)] of from 5/95 to 45/55.

6. The method for producing carbon-containing silicon carbide ceramics according to any one of claims 1 to 5, wherein the carbon-containing silicon carbide ceramics have a relative density of 85% or more, a carbon domain diameter is from 0.1 to 10 μm, and a ratio of the carbon domain of from 6 to 70% by volume.

7. Carbon-containing silicon carbide ceramics obtained by the method as defined in any one of claims 1 to 6.

8. A sliding member or a high-temperature structural member made of the carbon-containing silicon carbide ceramics as defined in claim 7.
